(19) United States
(12) Patent Application Publication
(10) Pub. No.: US 2010/0329293 A1
(43) Pub. Date: Dec. 30, 2010

(54) Methods and Apparatus for Efficient, Low-noise, Precision Current Control

(75) Inventor: Matthew S. Taubman, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: BATTELLE MEMORIAL INSTITUTE, Richland, WA (US)

(21) Appl. No.: 12/492,390

(22) Filed: Jun. 26, 2009

(51) Int. Cl. H01S 3/10

(52) U.S. Cl. 372/38.02

(57) ABSTRACT

Improved current controllers of the present invention provide efficient, low noise, precision current control for devices having such operational requirements. The current controllers are characterized by a PWM regulator operably connected to a linear regulator. The PWM regulator regulates a voltage drop across the linear regulator, wherein the voltage provided to the linear regulator is greater than the output voltage of the linear regulator by a controlled operating margin. The PWM provides efficient power conversion and minimizes waste power dissipation in the linear regulator. The linear regulator, in turn, provides low noise, precision current drive to the connected load.

### STATEMENT REGARDING FEDERALLY SPONSORED RESEARCH OR DEVELOPMENT

This invention was made with Government support under Contract DE-AC0576RL01830 awarded by the U.S. Department of Energy. The Government has certain rights in the invention.

### BACKGROUND

A number of devices require regulated power characterized by high precision, low noise, and high efficiency. Examples can include lasers and, in particular, quantum cascade lasers (QCL). Typically, linear regulator controllers are used for sensitive applications, yielding low noise, rapid control, and high reliability. However, linear regulator controllers tend to be bulkier and less efficient than pulse-width modulated (PWM) controllers. This is a particularly relevant issue for QCLs, which are typically more power hungry than other semiconductor lasers. Accordingly, an improved current controller is needed to provide efficient, low noise, precision current control for devices having such operational requirements.

### SUMMARY

The present invention provides a compact, efficient, high performance current controller. The controller is stable across the operating range. Embodiments encompass current controllers characterized by a PWM regulator operably connected to a linear regulator. The PWM regulator regulates a voltage drop across the linear regulator, wherein the voltage provided to the linear regulator is greater than the output voltage of the linear regulator by a controlled operating margin. The PWM provides efficient power conversion and minimizes waste power dissipation in the linear regulator. The linear regulator, in turn, provides low noise, precision current drive to the connected load.

As used herein, the controlled operating margin refers to a pre-determined voltage differential between the voltage supplied by the PWM regulator and the output voltage of the linear regulator. The PWM regulator output voltage (supplied to the linear regulator) tracks the linear regulator output voltage, in order to maintain the desirable operating voltage margin, which in turn allows the linear regulator to provide the requisite power to an attached load or device, while minimizing the dissipated power. Accordingly, the voltage provided by the PWM regulator to the linear supply will vary with the output voltage of the linear supply and will remain higher by an approximately constant operating margin. In one example, the controlled operating margin is approximately 3 volts.

In a preferred embodiment, the PWM regulator is voltage regulated. Furthermore, the linear regulator can be current regulated.

In another embodiment, the current controller is externally modulated.

The current controller can further comprise a dynamic snubber providing active correction of the voltage provided to the linear regulator by the PWM regulator, wherein the dynamic snubber is operably connected to the PWM and the linear regulator. An exemplary dynamic snubber can comprise a high-output buffer driving a snubber consisting of resistive and reactive components, wherein the linear regulator output is connected to the buffer input, either directly or via appropriate filtering components to tailor the response of the active snubber network.

While the current controller is suitable for driving any number of devices, it can be especially well suited for modification to drive semiconductor lasers, and in particular, quantum cascade lasers.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 is a circuit diagram depicting one embodiment of the present invention.

FIG. 2 is a detailed circuit diagram depicting one embodiment of the present invention.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

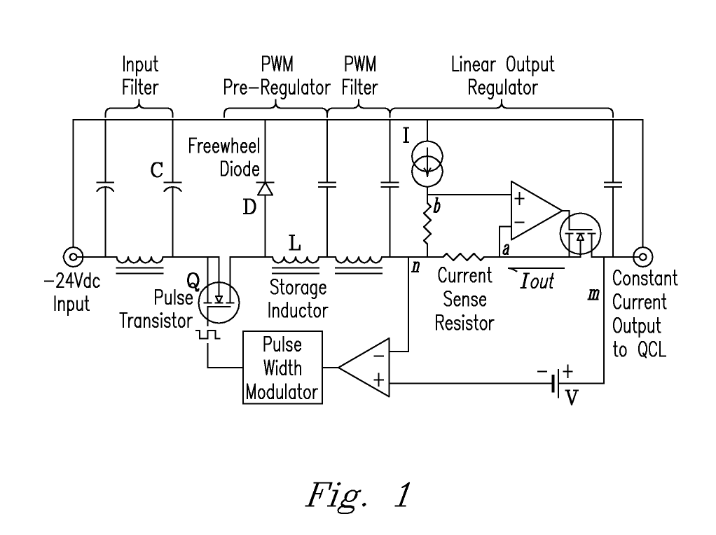

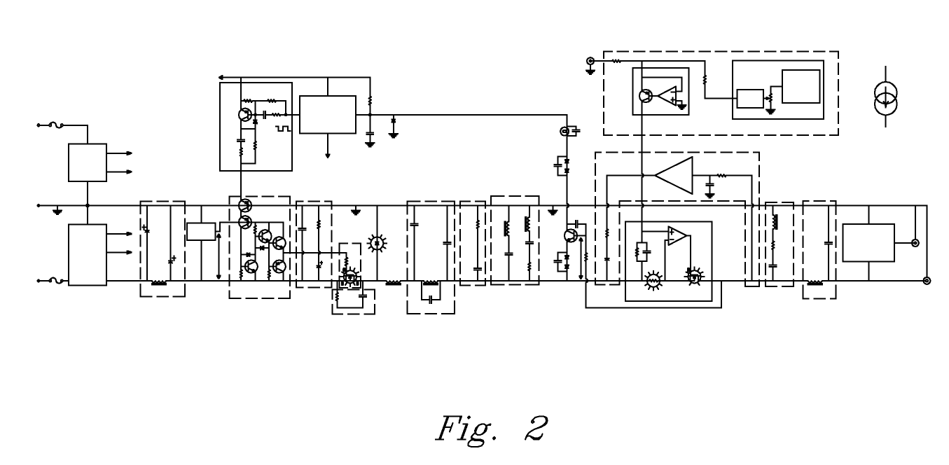

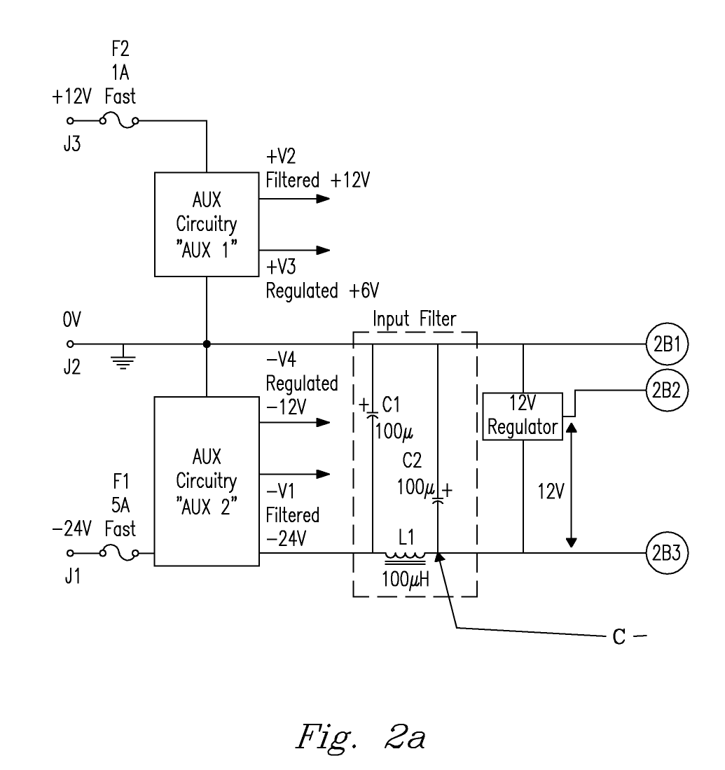

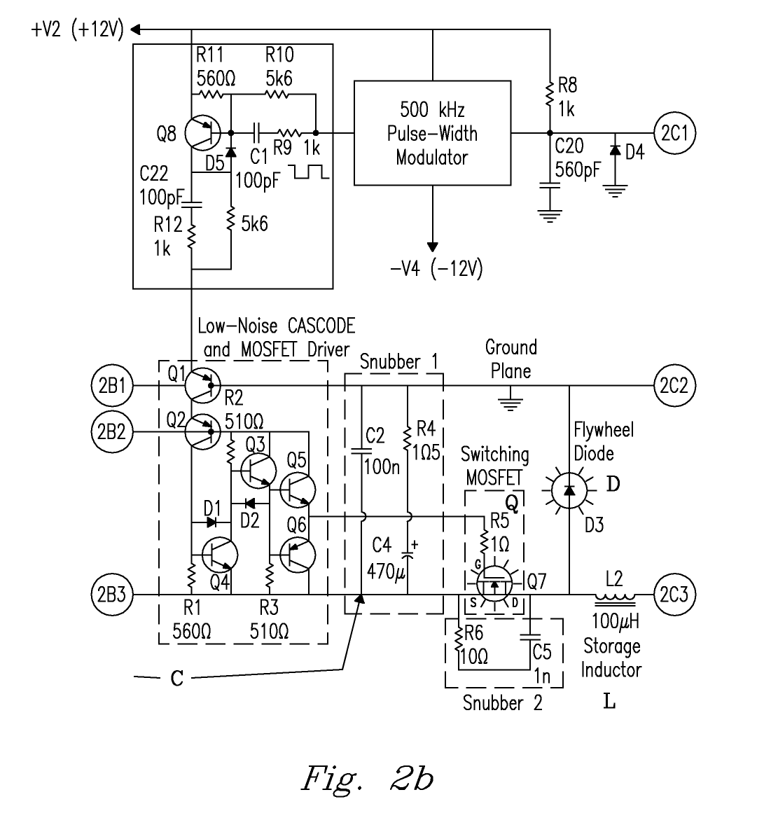

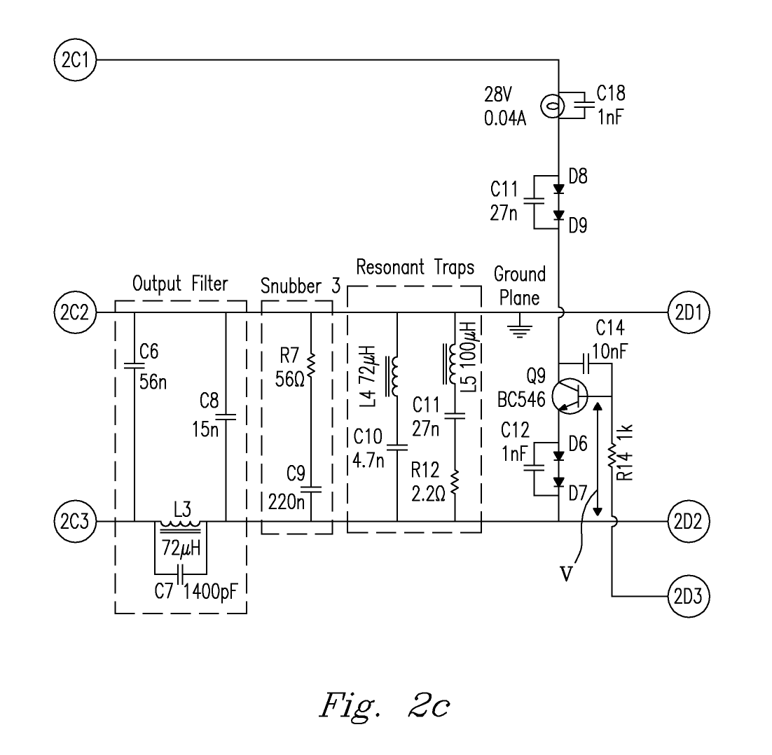

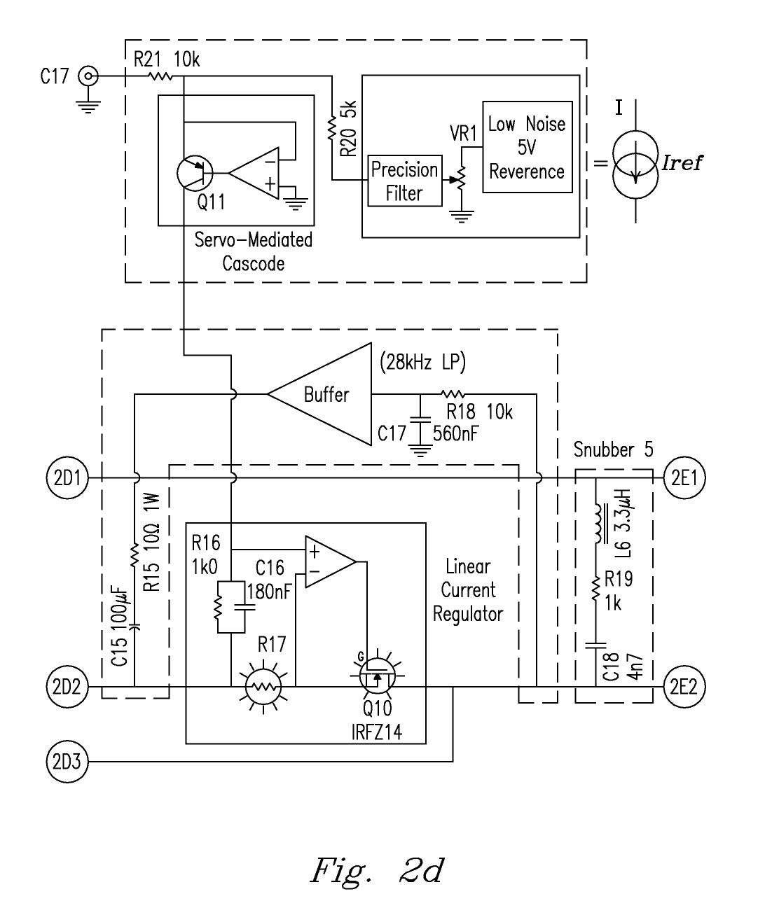

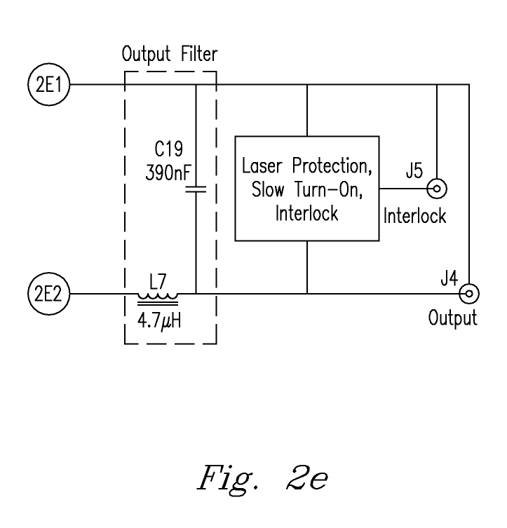

FIGS. 1 and 2 show a variety of embodiments and/or aspects of the present invention. Referring first to FIG. 1, a circuit diagram illustrates one embodiment of the present invention. The circuit flows logically from left to right and comprises an Input Filter, the PWM Pre-regulator, a PWM Filter, and the Linear Output Regulator.

The input appears to the lower left of the diagram, nominally specified as negative 24 Volts DC, although this is not a limitation. This feeds the first section of the unit, the Input Filter, which reduces the impact on the circuit or system supplying the −24 Vdc to the unit, of any noise generated within the PWM regulator. This filter consists of a capacitor-inductor-capacitor or Pi-filter architecture, providing a third order filtering function for good noise rejection, and the output capacitor C providing low impedance support for the PWM block, which follows.

The Input Filter drives the PWM Pre-regulator block. The first element of this block is a switching transistor Q, which is in practice a Metal-Oxide-Silicon-Field-Effect-Transistor (MOSFET). MOSFET Q is switched on and off rapidly, providing periodic application of the filtered drive voltage to the first series inductor L, also called the Storage Inductor. Since the nature of inductance is to resist a change in current, that current flowing through inductor L at the instant MOSFET Q turns off continues to flow through L, but through flyback diode D instead of through Q. This allows periodic application of voltage to L to produce beyond L, a continuous DC current with a triangular superimposed AC component, the rising components of which correspond to the periods when input voltage is applied to L, and the falling to the periods when voltage is removed and D is conducting instead.

The capacitor-inductor-capacitor, or Pi-architecture, which follows, is the PWM Filter. The purpose of this filter is to smooth out the current flow (or equivalently the voltage) after the PWM block, thus removing the AC triangular wave component and leave the average DC component, which is then passed to the Linear Output Regulator Block.

The Linear Output Regulator Block is furnished with filtered current from the PWM Filter. In this block a second MOSFET regulates the current flow to the output of the unit and thence to the QCL, or other load. The regulator MOSFET is in turn controlled by an operational amplifier, which maintains output current flow lout (shown here to be pointing to the left away from the output, since this configuration is one of negative polarity and thus exhibits negative current) such that the voltage levels a and b are equal, thus equalizing the voltages across a current sense resistor and a reference resistor, that latter being fed by a constant current source I with reference current Iref.

The Pulse Width Modulator provides the operating signals to the MOSFET Q, and varies the pulse width ratio to obtain the desired operating voltage margin between the output of the PWM Block and the output of the Linear Regulator Block. The sensing of this operating margin is represented by a differential amplifier with inputs from m and n, taken from the outputs of the Linear and PWM blocks respectively, with that from the Linear output (m) passing through a voltage offset V. A small capacitor at the output of the Linear Regulator Block ensures stability of the unit.

Referring to FIG. 2, a detailed circuit diagram depicts a particular embodiment of the invention. The illustrated circuit is a negative polarity or “positive-ground” circuit, providing a negative polarity output current to a circuit load, which in the present embodiment is a laser device.

Power enters via connectors J1, J2 and J3, with +2; V being supplied at J3, −24V at J1, and zero (i.e., common) at J2. Auxiliary circuitry “Aux 1” and “Aux 2” provide reverse input polarity protection, input over-voltage protection, safety shutdown of the negative rail if the positive rail is not active, and the generation of filtered power rails at −24V and +12V, and regulated power rails at −12V, and +6V.

Power flows through the input filter block, which prevents reverse contamination of the power source driving the instant current controller. The final capacitor of this block, C, provides storage and low impedance for the switching regulator that follows. Inductor L1 can be constructed using a high permeability iron core material intended to operate at DC, and which exhibits significant loss above 1 MHz, enhancing the effect of this filter. C is shown here to consist of two capacitors, C2 and C3. C2 provides larger stored energy, while C3 is smaller and responds to higher frequencies better than C2. C3 also forms part of the noise reduction circuit Snubber 1.

The switching regulator is operated by a 500 kHz pulse-width modulator circuit, designed and constructed from standard CMOS 4000 series logic and comparators. The square wave produced by this unit operates a driver stage centered on Q8. This unit is empirically optimized to produce fast rise and fall times, while producing a minimum of ringing and spurious transients. This is achieved by the surrounding resistor-capacitor networks, which provide short-term low impedance drive for turn on, but higher impedance sustained drive, allowing lower saturation and cleaner turn-off. The diode D5 also prevents Q8 from saturating, facilitating rapid turn-off.

Current from the low transient driver stage is reflected across the ground node via cascode transistor Q1, and over the local MOSFET power rail via cascode transistor Q2. The presence otherwise of this current determines the on or off state of Q4. When on, Q4 removes drive from Q3 directly, and rapidly removes drive from Q5 via D2. Q6 keeps the gate (G) of Q clamped near its source (S) voltage, keeping it off. When Q4 is off, R2 turns Q3 on, turning Q6 off and Q5, rapidly applying 12V between the G and S of Q. Diode D1 prevents Q4 from saturating, allowing rapid turn off and helps prevent transients.

Snubber 1 is empirically determined to reduce low frequency ringing observed at S of Q under certain circumstance. The relatively large value of C4 ensures access to these frequencies, while R4 presents a loss to these signals, thus damping them.

Current pass through the storage inductor L (L2), made from a low loss powdered iron material intended for switch-mode power supply use. The flywheel diode D, a power Schottky device, completes the circuit through L and the load during times when Q is off.

The output filter reduces the current and voltage ripple present after the storage inductor L. Inductor L3 is made from similar DC filter materials to L1. The values of C6 and C8 are chosen following filter design principles to reduce transient effects. The capacitor C7 in paralleled with L3 provides a resonant block at the fundamental of the modulation frequency, 500 kHz.

Snubber 3 operates in a similar manner to Snubber 1, reducing ringing due to the switching action of Q by providing losses and thus damping to these frequencies.

The resonant trap block that follows provides rejection of specific frequencies appearing at this point in the circuit by using tuned inductor-capacitor circuits. The first resonant trap removes significant amounts of the remaining noise at the fundamental switching frequency, 500 kHz. The second provides damping for low levels of noise observed at 100 kHz, which are likely due to residual effects of the preceding filter architectures.

Power passes then to the linear current regulator block. A particularly suitable linear current regulator is described in U.S. Pat. No. 6,867,644. The regulator block can be controlled by a servo-mediated cascode, one of which is described in U.S. Pat. No. 6,696,887, which in turn is fed by a reference block. Both the U.S. Pat. Nos. 6,867,644 and 6,696,887 patents are incorporated herein by reference. The servo-mediated cascode and the reference block together form the constant current source indicated to the right of the diagram, and represented in FIG. 1. The unit can be internally controlled by deriving a fixed voltage from the reference block, or externally controlled using input J6, which in turn could be driven by an external voltage source, a computer, or function generator.

Snubber 5 prevents ringing of the linear regulator, and the output filter ensures high frequency contributions are suppressed. There is a laser protection circuit near the output, which provides an operating short on circuit power-up protecting any applied load, and providing slow turn-on and an interlock feature.

With regard to the control of the switching regulator, transistor Q9 and associated components allow a comparison of the voltage before and after the linear regulator stage. When the voltage before the linear stage falls farther than the Vbe junction voltage of Q9 plus the junction voltage of the two signal diodes D6 and D7, Q9 begins to turn on. Thus, the sum of the above-mentioned voltage drops forms the indicated offset voltage V, which was represented without loss of generality by a voltage source in FIG. 1.

When Q9 conducts, it pulls a current through R8, thus dropping the voltage at the cathode of D4, which in turn decreases the mark-space ratio of the pulse-width modulator output, which in turn reduces the on-time of Q, allowing the output voltage of the switching regulator stage to fall to a point where a steady state is reached with Q9 only partially conducting. Capacitor C20 near the PWM unit and C 14 around Q9 provide stabilization of this control action. The light bulb in this circuit provides current-depended resistance, and is thus used as a current limiting device that doesn't interfere with circuit operation when not needed. Diodes D8 and D9 reduce clipping of the output waveform of the current controller under certain circumstance.

One consideration in making the PWM voltage pre-regulator operate with the Linear current regulator in a stable manner, is not to provide too much gain between the two stages. Hence, the link between the two is a single transistor, Q9, the action of which is discussed above. However, due to the modest gain that results, the PWM voltage pre-regulator cannot follow very rapid variations in output voltage of the linear regulator without some ringing. To improve this performance, active correction can be provided by a dynamic snubber such as Snubber 4.

Snubber 4 operates by using a high output current buffer to drive a snubber configuration, R15 and C15. The input of the buffer is connected to the output of the linear stage via a low pass filter formed by R18 and C17, possessing a 3 dB roll off point around 28 kHz. The result is that below this frequency, the buffer drives the snubber to follow the output, providing support to the PWM output with minimal current flow by mimicking the output of the linear stage. At frequencies above 28 kHz, this buffer is essentially grounded, meaning that the snubber provides a pathway to ground for higher frequency noise and other spurious signals. In this manner, large currents (if necessary) can flow through this snubber circuit at higher frequencies to a virtual ground provided by the buffer, while large slower waveforms do not result in high dissipation and power loss through R15, because the buffer forces the snubber components to follow the output in these frequency ranges. With the Active Correction of Snubber 4, full scale (zero to two amperes) triangle wave output is obtained into a resistive load at 1 kHz with practically no ringing. Higher frequency waveforms have been demonstrated into actual laser devices (which exhibit less voltage variation than resistive loads) also with little or no ringing.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A current controller characterized by a pulse-width modulated (PWM) regulator regulating a voltage drop across an operably connected linear regulator, wherein a voltage provided to the linear regulator by the PWM regulator is greater than an output voltage of the linear regulator by a controlled operating margin.

2. The current controller of claim 1, wherein the PWM regulator is voltage-regulated.

3. The current controller of claim 2, wherein the linear regulator is current regulated.

4. The current controller of claim 3, further comprising a dynamic snubber providing active correction of the voltage provided to the linear regulator by the PWM regulator, wherein the dynamic snubber is operably connected to the PWM and the linear regulator.

5. The current controller of claim 4, wherein the dynamic snubber comprises a high-output buffer driving a snubber, wherein the linear regulator output is connected to the buffer input.

6. The current controller of claim 1, operably connected to a semiconductor laser and providing power to the semiconductor laser.

7. The current controller of claim 6, wherein the semiconductor laser is a quantum cascade laser.

8. The current controller of claim 1, further comprising an operably connected external modulator that modulates the PWM and the linear regulator.

9. A method of providing efficient, low-noise current control, the method characterized by decreasing a voltage drop across a linear regulator by supplying power first through a PWM regulator, wherein the PWM regulator provides a voltage that is greater than an output voltage of the linear regulator by an amount sufficient to allow operation of the linear regulator with a controlled operating margin.

10. The method of claim 9, wherein the PWM regulator is voltage-regulated

11. The method of claim 10, wherein the linear regulator is current regulated.

12. The method of claim 11, further comprising actively correcting via a dynamic scrubber the voltage provided to the linear regulator by the PWM regulator, wherein the dynamic snubber is operably connected to the PWM and the linear regulator.

13. The method of claim 12, wherein the dynamic snubber comprises a high-output buffer driving a snubber, wherein the linear regulator output is connected to the buffer input.

14. The method of claim 9, further comprising providing the output of the linear regulator as a power supply to an operably connected semiconductor laser.

15. The method of claim 14, wherein the semiconductor laser is a quantum cascade laser.

16. The method of claim 9, further comprising externally modulating the PWM and linear regulators.
